(19) United States
(12) Patent Application Publication
(10) Pub. No.: US 2022/0377199 A1
(43) Pub. Date: Nov. 24, 2022

(54) PRINTING IMAGE-INDEPENDENT PRINT DATA BASED ON PIXEL CHARACTERISTICS

(71) Applicant: Hewlett-Packard Development Company, L.P., Spring, TX (US)

(72) Inventor: Bradley R. LARSON, Boise, ID (US)

(73) Assignee: Hewlett-Packard Development Company, L.P., Spring, TX (US)

(21) Appl. No.: 17/767,319

(22) PCT Filed: Oct. 24, 2019
(86) PCT No.: PCT/US2019/057908

§ 371 Date: Apr. 7, 2022

(51) Int. Cl. H04N 1/32; H04N 1/60

(52) U.S. Cl. CPC H04N 1/32229; H04N 1/6008; H04N 1/32219

(57) ABSTRACT

According to examples, an apparatus may include a processor that may access a window of pixels corresponding to print data. The print data may specify printing of a plurality of pixels based on an original document image and image-independent print data. The apparatus may identify a first pixel, from among the window of pixels, corresponding to the image-independent print data, determine a characteristic associated with the window of pixels, determine, based on the characteristic, that the image-independent print data is to specify printing of a second pixel from among the window of pixels. The apparatus may cause the image-independent print data to specify printing of the second pixel based on the determination that the image-independent print data is to specify printing of the second pixel.

### BACKGROUND

A printer may print metadata such as a security feature or watermark along with print content on a document. The metadata may encode information relating to a print job for printing the document, such as a printer identification, a date of printing, a time of printing, an identification of who printed the document, and/or other information relating to the document. In particular examples, the metadata may be printed as a pattern, such as a pattern of printed dots, that may be later decoded by an imaging device such as a scanner or camera. To obfuscate the pattern, a printer may print the metadata using a size, shape, and/or color of dots that may blend with the document in a manner that is generally not visible to the human eye. When print data that includes print content, such as an original document image, is received for printing by a printer, the printer may add the metadata to the print data and then print the original document image and the metadata.

### BRIEF DESCRIPTION OF THE DRAWINGS

Features of the present disclosure may be illustrated by way of example and not limited in the following figure(s), in which like numerals indicate like elements, in which:

FIG. 1 shows a block diagram of an example apparatus that may render image-independent print data based on characteristics of windows of pixels;

FIG. 2 shows an example of print data that may include an original document image and image-independent print data to be printed;

FIG. 3 shows an example of windows of pixels of the print data shown in FIG. 2;

FIG. 4A shows an example of individual pixels, including a pixel corresponding to the image-independent print data shown in FIG. 2, in a window of pixels;

FIG. 4B shows an example of individual pixels in a window of pixels and weighting of the individual pixels as a function of distance from the pixel corresponding to the image-independent print data shown in FIG. 2;

FIG. 5 depicts an example data flow for rendering image-independent print data based on characteristics of windows of pixels;

FIG. 6 depicts a flow diagram of an example method for modifying a property of the image-independent print data based on a characteristic of a window of pixels;

FIG. 7 depicts a block diagram of an example non-transitory machine-readable storage medium for modifying a property of the image-independent print data based on a characteristic of a window of pixels;

FIG. 8 depicts a flow diagram of an example hardware block implementation for modifying a property of the image-independent print data based on a characteristic of a window of pixels; and

FIG. 9 depicts a flow diagram of an example hardware block implementation for, as disclosed herein throughout, modifying a property of the image-independent print data based on a characteristic of a window of pixels for monochromatic data.

### DETAILED DESCRIPTION

For simplicity and illustrative purposes, the present disclosure may be described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” may be intended to denote at least one of a particular element. As used herein, the term “includes” means includes but not limited to, the term “including” means including but not limited to. The term “based on” means based at least in part on.

The present disclosure generally relates to printing metadata such as a security feature or watermark along with print content on a document. A problem that may arise when printing such metadata with the print content is that the tone of certain parts of the print content may interfere with the appearance of the printed metadata. For example, the metadata may not be sufficiently visible in dark regions of the document (making decoding the metadata difficult) or may appear darker than intended in light regions of the document (rendering the metadata visible to the human eye).

The present disclosure may employ computational analysis of pixel characteristics to modify the metadata that is printed. For example, an apparatus may analyze, within a print pipeline, print data. The print data may include document image print data that specifies pixels for a document and image-independent print data that specifies pixels of the metadata. In particular, the apparatus may determine a characteristic, such as level of darkness, of a window of pixels of the print data. Based on the characteristic, the apparatus may vary the size and/or shape of the pixels specified by the image-independent print data. Doing so may, in certain regions based on the characteristic of those regions, be printed in a manner that the image-independent print data is detectable as if unchanged. For example, even though the size or shape of the image-independent print data has been changed, because of the characteristic, such as level of darkness of neighboring pixels, the image-independent print data when printed may be detected as if unchanged. In this manner, the apparatus may take into account the level of darkness of pixels of the print content that are neighbors of metadata pixels. In some examples, the apparatus may also vary the tone or color of the metadata pixels based on the characteristic to similarly make the image-independent print data detectable as if unchanged based on the characteristic of neighboring pixels.

The apparatus may use a single pattern of print data in which pixels may be pre-marked as corresponding to metadata into an Object Type (OT) plane without having to duplicate the document image for analysis. The disclosure may therefore reduce the storage footprint of pre-marking the metadata pixels, making such pre-marking re-usable and efficient for each page of the entire document. In some examples, the OT plane may generally be 1 bit per pixel or 2 bits per pixel vs 24-bits per pixel for a regular color image overlay plane. Thus, processing on the OT plane may reduce memory used for processing. The apparatus disclosed herein may facilitate analysis of windows of pixels of the print data on the fly as the pixels are processed in a print pipeline with minimal additional computational overhead. For example, instead of expending additional CPU processing time and energy on analyzing the print data up-front when rendering each page, the apparatus of the present disclosure may instead use dedicated hardware on-the-fly within a print pipeline that occurs prior to printing.

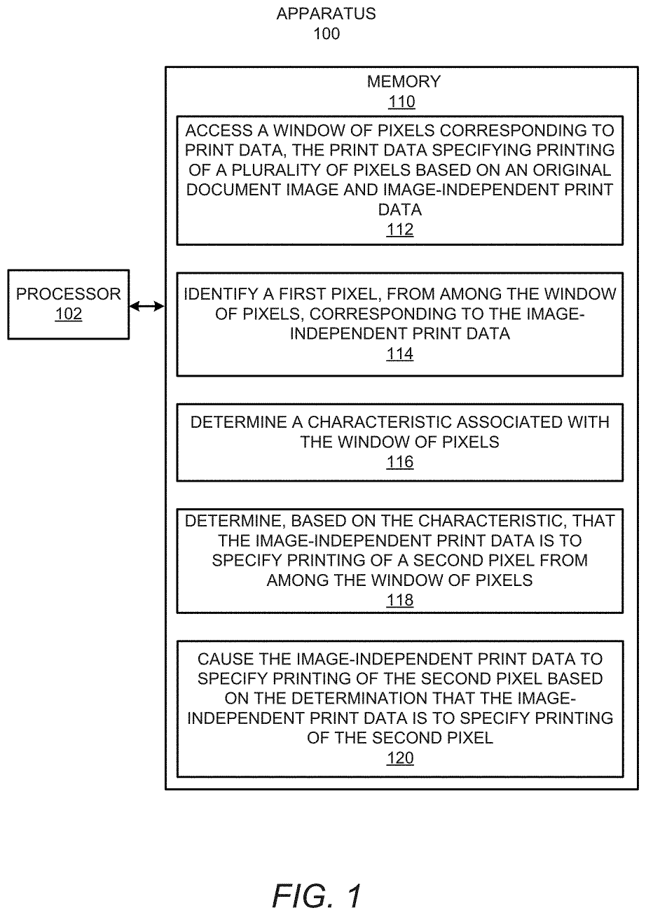

FIG. 1 shows a block diagram of an example apparatus 100 that may render image-independent print data based on characteristics of windows of pixels. It should be understood that the example apparatus 100 depicted in FIG. 1 may include additional features and that some of the features described herein may be removed and/or modified without departing from the scope of the example apparatus 100.

The apparatus 100 shown in FIG. 1 may be a computing device, a server, or the like. As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. Although the apparatus 100 has been depicted as including a single processor 102, it should be understood that the apparatus 100 may include multiple processors, multiple cores, or the like, without departing from the scopes of the apparatus 100 disclosed herein.

The apparatus 100 may include a memory 110 that may have stored thereon machine-readable instructions (which may also be termed computer readable instructions)112-120 that the processor 102 may execute. In some examples, the instructions may include firmware that programs a dedicated processor. The memory 110 may be an electronic, magnetic, optical, or other physical storage device that includes or stores executable instructions. The memory 110 may be, for example, Random Access memory (RAM), an Electrically Erasable Programmable Read-Only Memory (EEPROM), a storage device, an optical disc, and the like. The memory 110 may be a non-transitory machine-readable storage medium, where the term “non-transitory” does not encompass transitory propagating signals. Attention will now turn to example operations at processor 102.

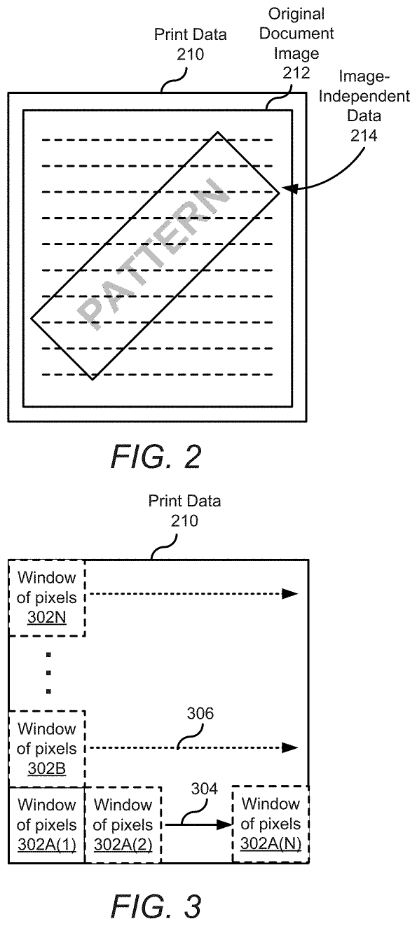

Referring to FIG. 1, the processor 102 may fetch, decode, and execute the instructions 112 to access a window of pixels corresponding to print data, the print data specifying printing of a plurality of pixels based on an original document image and image-independent print data. Examples of the print data, original document image, image-independent print data, and window of pixels referred to in FIG. 1 are illustrated with respect to FIGS. 2, 3, 4A, and 4B.

The processor 102 may fetch, decode, and execute the instructions 114 to identify a first pixel, from among the window of pixels, corresponding to the image-independent print data. The processor 102 may identify more than one pixel, from among the window of pixels, corresponding to the image-independent print data. Thus, the term “first pixel” is not necessarily limited to a single pixel.

The processor 102 may fetch, decode, and execute the instructions 116 to determine a characteristic associated with the window of pixels. In some examples, the characteristic may include a level of darkness of the pixels. For example, the processor 102 may determine, for one or more pixels in the window of pixels, a value of a color of each pixel of the one or more pixels and calculate an aggregate color value based on an aggregation of each value of the color determined for each pixel of the one or more pixels, the level of darkness being based on the aggregate color value. For example, the processor 102 may determine a value of a color of some or all of the pixels in the window of pixels, which may (in some examples) include the pixels corresponding to the image-independent print data. The color value may include Cyan, Magenta, Yellow, or Black.

In some examples, the processor 102 may calculate a respective aggregate color value for each of a plurality of colors to generate a plurality of aggregate color values, the level of darkness being based on the plurality of aggregate color values. For example, the processor 102 may calculate a first aggregate color value for Cyan, a second aggregate color value for Magenta, a third aggregate color value for Yellow, and/or a fourth aggregate color value for Black. The processor 102 may generate each of the aggregate color values by aggregating respective color values of each color. For example, the first aggregate color value may be generated for Cyan by aggregating Cyan color values of some or all pixels in the window of pixels; the second aggregate color value may be generated for Magenta by aggregating Magenta color values of some or all pixels in the window of pixels; the third aggregate color value may be generated for Yellow by aggregating Yellow color values of some or all pixels in the window of pixels; the fourth aggregate color value may be generated for Black by aggregating Black color values of some or all pixels in the window of pixels, and so forth.

In some examples, the processor 102 may apply a weight to each respective aggregate color value. The weight may adjust up or down the value of the aggregate color value. The weight may be predefined and/or configurable to adjust the aggregate color value. The weight may be customized for specific devices such as specific printer devices. For example, default values for the weights may be generated based on tuning the values for specific printers during development of the printers or implementing features of the disclosure herein into existing printers or other devices.

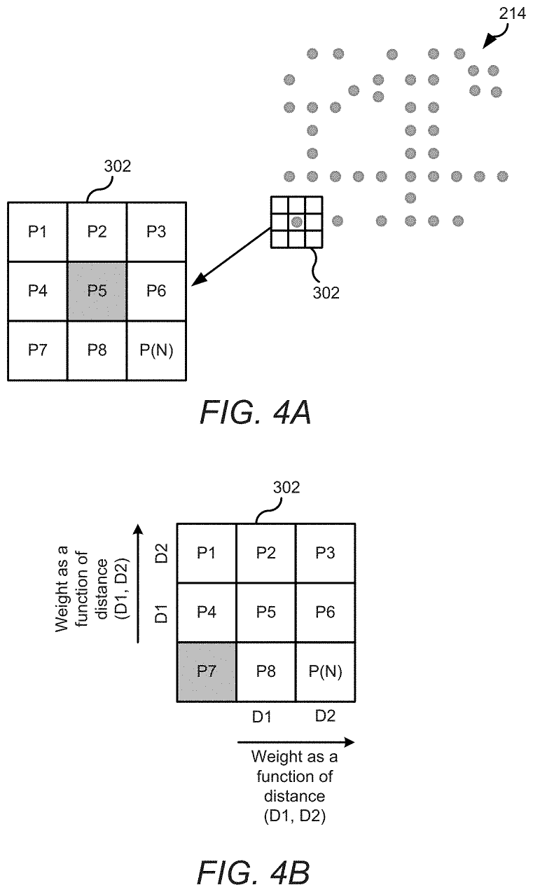

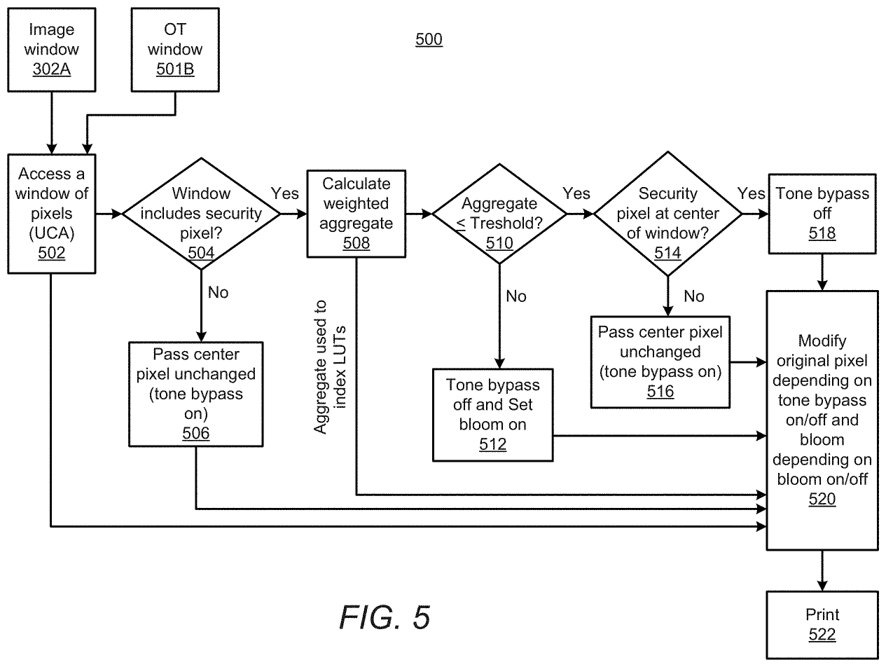

In some examples, the processor 102 may apply different weights, each weight having a value that is different than a value of another weight. For example, the processor 102 may apply a weight to an aggregate color value of a pixel in the window of pixels based on a distance between the first pixel (the pixel associated with the image-independent print data) and the pixel. In some examples, the weight may be in an inverse function of the distance. For example, the processor 102 may apply a first weight to pixels that are next to the first pixel and apply a second (such as smaller) weight to pixels that are one pixel away from the first pixel, and continue applying smaller weights as distance from the first pixel increases. An illustration of such a weight as a function of distance is illustrated in FIG. 4A. In some examples, each color plane may be associated with a respective weight. For example, the processor 102 may apply a first weight to Cyan, a second weight to Magenta, a third weight to Yellow, a fourth weight to Black, and so forth.

In some examples, the processor 102 may determine an overall aggregate color value based on some or all of the weighted aggregate color values. For example, the overall aggregate color value may be based on an aggregation of the aggregate Cyan color value, the aggregate Magenta color value, the aggregate Yellow color value, and/or the aggregate Black color value.

In some examples, the processor 102 may, depending on the characteristic of the window of pixels, change a property of the image-independent print data. For example, the processor 102 may change the color of each of the first pixel and the second pixel based on the aggregate color value (or overall aggregate). In this manner, depending on the level of darkness as indicated by the aggregate color value (of Cyan, Magenta, Yellow, and/or Black, for example), the processor 102 may change the color or other property of the image-independent print data so that the pixels corresponding to the image-independent print data may be printed in a manner that takes into account the level of darkness of the pixels surrounding the image-independent print data.

The processor 102 may fetch, decode, and execute the instructions 118 to determine, based on the characteristic, that the image-independent print data is to specify printing of a second pixel from among the window of pixels. For example, the processor 102 may compare the level of darkness to a threshold level of darkness, and determine that the level of darkness exceeds the threshold level of darkness. The threshold level of darkness may be predefined and/or configurable. The determination that the image-independent print data is to also be printed at the second pixel may be based on the determination that the level of darkness exceeds the threshold level of darkness.

The processor 102 may fetch, decode, and execute the instructions 120 to cause the image-independent print data to specify printing of the second pixel based on the determination that the image-independent print data is to specify printing of the second pixel. In some examples, the processor 102 may do so by copying the image-independent print data of the first pixel to the second pixel. Thus, the image-independent print data may be bloomed, or copied, from the first pixel to the second pixel responsive to a determination that the level of darkness exceeds a threshold level of darkness and/or responsive to another trigger to bloom from the first pixel to the second pixel.

In some examples, to determine that the image-independent print data is to also be printed at the second pixel, the processor 102 may identify a direction from the first pixel to which to expand the image-independent print data to change a shape of the image-independent print data. For example, the processor 102 may identify whether to bloom the image-independent print data up, down, left, right, diagonally up/left, diagonally up/right, diagonally down/left, and/or diagonally down/right (assuming a grid-like orientation of the window of pixels, as illustrated by the window of pixels 302 shown in FIG. 4A).

In some examples, the operations illustrated in FIG. 1 may be performed at the processor 102 at pre-halftone and/or post color-separation phases of a print pipeline. For example, the operations may be pre-halftone since local densities (of toner, for example) may be more easily determined versus post-halftone. The operations may be post color-separation so that toner densities, including Black-intent (K-intent), may be accounted for, may enable more precise control over Yellow and Black planes, and current print pipelines may be leveraged to implement the operations to improve printing of image-independent print data described herein.

FIG. 2 shows an example of print data 210 that may include an original document image 212 and image-independent print data 214 to be printed. The print data 210 may be used to print a document. For example, the print data 210 may specify pixel or other document positions at which to apply ink. The print data 210 may include the original document image 212 that specifies a document to be printed, such as a document that is transmitted to a printer for printing. The image-independent print data 214 may be added to the print data 210 to be printed with the original document image 212. As such, a printed document using the print data 210 will include the printed original document image 212 and the printed image-independent print data 214. The image-independent print data 214 may be metadata that encodes a pattern to be printed. The pattern may include a pattern of pixels. The pattern of pixels may be printed as a particular color, such as a shade of yellow or other color, based on steganographic techniques used by printers to print a pattern that is generally not visible by the naked eye but is recognizable when imaged. The data encoded by the pattern specified by the image-independent print data 214 may vary according to particular needs.

Prior to causing the printing of the print data 210 (which includes the original document image 212 and the image-independent print data 214), an apparatus, such as apparatus 100 illustrated in FIG. 1, may process the print data 210 to determine whether the image-independent print data 214 is to be modified. Such processing may address various problems associated with printing the image-independent print data 214 with the original document image 212, such as when some or all of the image-independent print data 214 is within a dark or light region of the original document image 212.

For example, as previously noted, the apparatus may analyze a window of pixels of the print data 210 to determine a characteristic (such as level of darkness) associated with the window of pixels. FIG. 3 shows an example of windows of pixels 302 of the print data 210. The apparatus may scan through pixels of the print data 210 based on sliding windows of pixels 302 throughout the print data 210 as indicated by solid arrow 304 and dashed arrows 306. Such sliding may occur pixel-by-pixel (not shown) or based on window width (as shown in FIG. 3). Sliding and direction of sliding are shown for illustration. Other directions for window sliding may be used as well, and different windows may be analyzed in a non-sliding fashion as well. Regardless of how the windows of pixels 302 are selected and traversed, the apparatus may analyze a window of pixels 302 to determine a characteristic of the window. Although a 3×3 pixel window is illustrated, it should be noted that other numbers of pixels and other configurations of windows (instead of a square grid of pixels) may be used as well.

FIG. 4A shows an example of individual pixels (P1-P(N)), including a pixel (P5) corresponding to the image-independent print data 214, in a window of pixels 302. As illustrated, the image-independent print data 214 may be a pattern of dots to be printed. A window of pixels 302 may be analyzed that correspond to one or more of the dots to be printed in the pattern. For example, the center pixel (P5) is illustrated as a pixel includes a dot to be printed. In this example, the characteristic of the window of pixels 302 may be based on a characteristic of each of the pixels neighboring the center pixel (P5). In some examples, the characteristic of the window of pixels 302 may be based further on a characteristic of the center pixel (P5) as well.

FIG. 4B shows an example of individual pixels (P1-P(N)) in a window of pixels 302 and weighting of the individual pixels (P1-P(N)) as a function of distance from a pixel (P7) corresponding to the image-independent print data. As illustrated, in some examples, the weighting of pixel characteristics described herein may be based on a distance from a pixel (P7) corresponding to the image-independent print data. For example, a weight applied to pixels P4, P5, and P8 (which are immediate neighbors to pixel P7) may be greater than a weight applied to pixels P1, P2, P3, P6, and P(N).

An example calculation of an overall weighted aggregate color value (C_{w}) for the window of pixels 302 shown in FIG. 4B follows, in which P7 corresponds to the image-independent print data (where * denotes multiplication):

C_{w}=(WcD2*c1+WmD2*m1+WyD2*y1)+(WcD2*c2+WmD2*m2+WyD2*y2)+(WcD2*c3+WmD2*m3+WyD2*y3)+(WcD1*c4+WmD1*m4+WyD1*y4)+(WcD1*c5+WmD1*m5+WyD1*y5)+(WcD2+c6+WmD2*m6+WyD2*y6)+(WcS*c7+WmS*m7+WyS*y7)+(WcD1*c8+WmD1*m8+WyD1*y8)+(WcD2*c9+WmD2*m9+WyD2*y9),
c1-cN refers to the Cyan color value at pixels P1-P(N);
m1-mN refers to the Magenta color value at pixels P1-P(N);
y1-yN refers to the Yellow color value at pixels P1-P(N);
WcD1 refers to the weight for Cyan at a first distance D1 from the image-independent print data (P7);
WcD2 refers to the weight for Cyan at a second distance D2 from the image-independent print data (P7);
WmD1 refers to the weight for Magenta at a first distance D1 from the image-independent print data (P7);
WmD2 refers to the weight for Magenta at a second distance D2 from the image-independent print data (P7);
WyD1 refers to the weight for Yellow at a first distance D1 from the image-independent print data (P7);
WyD2 refers to the weight for Yellow at a second distance D2 from the image-independent print data (P7);
WcS refers to the weight for Cyan at the image-independent print data (P7);
WmS refers to the weight for Magenta at the image-independent print data (P7); and

WyS refers to the weight for Yellow at the image-independent print data (P7).

In some examples, other numbers of distance-based weights may be used depending on the size of the window of pixels 302. For example, a third weight WcD3 may be used for a third distance from the image-independent print data (P7). It should also be noted that the weights may not be distance-dependent. For example, WcD1 may be equal to WcD2, WmD1 may be equal to WmD2, and WyD1 may be equal to WyD2. It should be further noted that the security pixel (image-independent data) may not have a different weight. For example, WcS may be equal to WcD1 and/or WcD2. In still other examples, each pixel may be assigned with a predetermined pixel weight based on the pixel's location in the window of pixels 302. In these examples, a given location of a pixel in the window of pixels 302 may be assigned with a predetermined pixel weight, which may be the same as or different from the predetermined pixel weight of another pixel at another location in the window of pixels 302.

FIG. 5 depicts an example data flow 500 for rendering image-independent print data based on characteristics of windows of pixels. The data flow may be implemented at a processor, such as processor 102 illustrated in FIG. 1.

At 502, the processor may access a window of pixels. In some examples, the processor may perform under color addition (UCA) to merge the Black color plane (K) with the other color planes (Cyan, Magenta, and Yellow —respectively, C, M, and Y). The window of pixels may include a window of pixels 302A corresponding to the original document image and OT window 501B corresponding to the object types of the print data to be printed. In some examples, the window of pixels 302A may be in a Red, Green, Blue (RGB) color space, which may be converted to a CMYK color space. A pixel corresponding to image-independent print data may be referred to herein throughout as a “security pixel” for convenience of illustration.

An example of UCA to convert from CMYK ->C′M′Y′ follows:

C′=C+K

M′=M+K

Y′=Y+K

Values over 100% may not be clipped in order to represent total toner density intent.

At 504, the processor may determine whether the window of pixels (collectively the windows 302A, B) includes a security pixel. For example, each pixel may be flagged as being associated with image-independent print data. In particular, a memory may set a flag for each pixel position indicating whether or not the pixel is associated with image-independent print data (a security pixel as shown in the flow diagram of FIG. 5). If a security pixel is not in the window of pixels, then the processor may proceed to 506, where the center pixel may be unchanged with tone bypass set to on (in memory). When tone bypass is set to on, the tone or color of the center pixel may be unchanged. On the other hand, when tone bypass is set to off, the tone or color of the center pixel may be changed as will be described later in the data flow). In some examples, the processor may access one or more user inputs that specify constraints relating to blooming. For example, the inputs may specify that only a certain bloom direction (the direction in which a security pixel is bloomed to another pixel) is permitted and/or certain bloom direction is restricted.

Returning to 504, if the window of pixels does include a security pixel, then, at 508, the processor may calculate a weighted aggregate, such as the examples of aggregate color values (which may be weighted) discussed with respect to FIGS. 1 and 4B. In some examples, the weighted aggregate may be later used for indexing color lookup tables (LUTs) for changing a tone of the center pixel. A LUT may include a lookup of a color value to another color value. Thus, the LUT may be used to convert from one color value to another color value. In particular, the processor may use a weighted aggregate as an index to a LUT to lookup color value to which to convert a given pixel of interest (such as the center pixel of the window of pixels). The LUT may be predefined or computed to map a given background color (such as a dark background color) with a color that is to be used for image-independent print data. In this manner, the LUT may map dark background colors to suitable colors to be used for printing security pixels or other image-independent print data. Accordingly, in some examples, a dark background color, as indicated by the weighted aggregate, and the LUT may be used to identify a suitable color to use for the security pixel or center pixel of the window of pixels.

At 510, the processor may determine whether any of the aggregate color values or the aggregate of all aggregate color values exceeds a predetermined threshold. If not, then the window of pixels 302 may be determined to be a dark region at 512. As such, the processor may set the tone bypass to off and set bloom on. On the other hand, if any of the aggregate color values or the aggregate of all aggregate color values does not exceed a predetermined threshold, the window of pixels may be determined to be in a light region and the processor may proceed to 514. At 514, the processor may determine whether the security pixel is at the center of the window of pixels 302. If the security pixel is not at the center of the window of pixels 302, then the processor may set the tone bypass to on at 516. On the other hand, if the security pixel is at the center of the window of pixels 302, then the processor may set the tone bypass off at 518.

At 520, the processor may determine whether tone bypass has been set to on or off. If set to off (do not bypass tone change), then the tone or color of the center pixel may be changed according to the LUT that is based on the aggregate color values from 508. In some examples, at 520, the processor may determine whether bloom is on. If so, then the processor may bloom the security pixel to another pixel. At 522, the processor may cause a document to be printed based on the resulting modified pixel data.

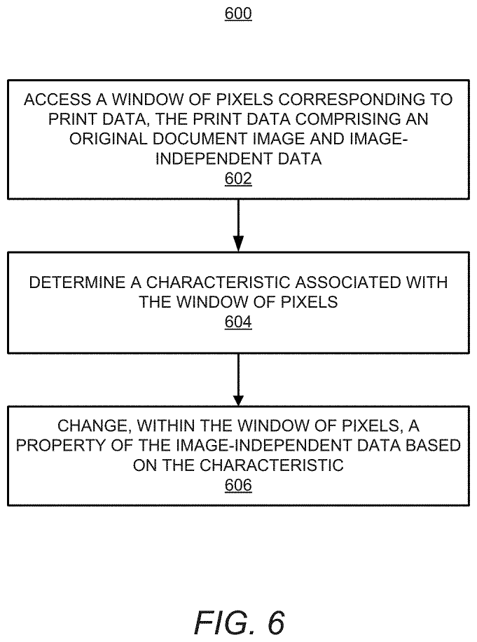

Various manners in which the apparatus 100 may operate to modify a property of the image-independent print data are discussed in greater detail with respect to the method 600 depicted in FIG. 6. It should be understood that the method 600 may include additional operations and that some of the operations described therein may be removed and/or modified without departing from the scopes of the method 600.

FIG. 6 depicts a flow diagram of an example method 600 for modifying a property of the image-independent print data based on a characteristic of a window of pixels. As shown in FIG. 6, at block 602, a processor, such as the processor 102 illustrated in FIG. 1, may access a window of pixels, such as the window of pixels 302 illustrated in FIGS. 3, 4A and 4B, corresponding to print data, such as print data 210 illustrated in FIGS. 2 and 3.

At block 604, the processor may determine a characteristic associated with the window of pixels. For example, the characteristic may include a level of darkness associated with pixels in the window of pixels. In this example, the characteristic may indicate a level of darkness of the print data in the window of pixels.

At block 606, the processor may change, within the window of pixels, a property of the image-independent print data based on the characteristic. For example, the processor may change a tone or color of the center pixel (and/or other pixel) of the window of pixels based on the characteristic. The property may include a size or shape of the image-independent print data. For example, the processor may change a size of the image-independent print data by blooming, or copying, a pixel of the image-independent print data to another pixel in the window of pixels. Alternatively, or additionally, the processor may change a shape of the image-independent print data by identifying a direction from the pixel of the image-independent print data to another pixel in the window to which to copy the pixel of the image-independent print data.

Some or all of the operations set forth in the method 600 may be included as utilities, programs, or subprograms, in any desired computer accessible medium. In addition, the method 600 may be embodied by computer programs, which may exist in a variety of forms. For example, some operations of the method 600 may exist as machine-readable instructions, including source code, object code, executable code or other formats. Any of the above may be embodied on a non-transitory computer readable storage medium. Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

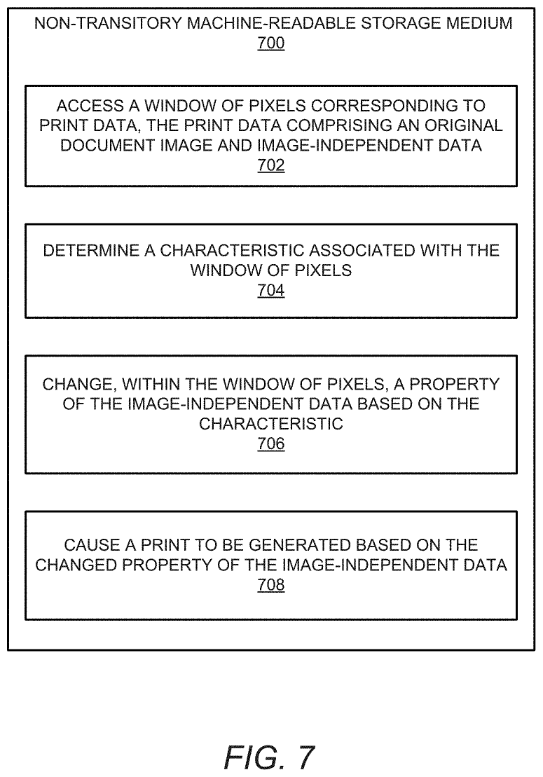

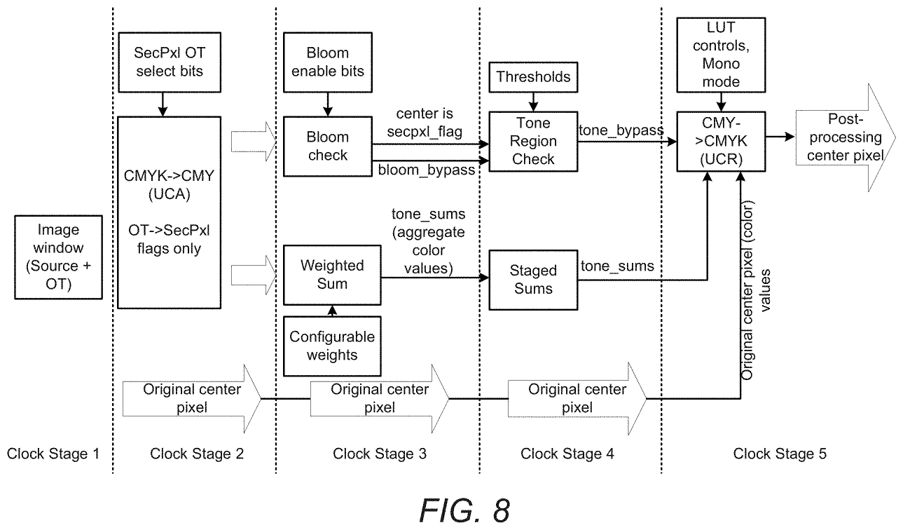

FIG. 7 depicts a block diagram of an example non-transitory machine-readable storage medium 700 for modifying a property of the image-independent print data based on a characteristic of a window of pixels. The non-transitory machine-readable storage medium 700 may be an electronic, magnetic, optical, or other physical storage device that includes or stores executable instructions. The non-transitory machine-readable storage medium 700 may be, for example, Random Access memory (RAM), an Electrically Erasable Programmable Read-Only Memory (EEPROM), a storage device, an optical disc, and the like. The non-transitory machine-readable storage medium 700 may have stored thereon machine-readable instructions 702-708 that a processor, such as the processor 102 illustrated in FIG. 1, may execute.

The machine-readable instructions 702 may cause the processor to access a window of pixels corresponding to print data, the print data comprising an original document image and image-independent print data.

The machine-readable instructions 704 may cause the processor to determine a characteristic associated with the window of pixels.

The machine-readable instructions 706 may cause the processor to change, within the window of pixels, a property of the image-independent print data based on the characteristic, the property comprising: a size of the image-independent print data in the window of pixels being defined by a number of pixels corresponding to the image-independent print data that are present in the window of pixels, and/or a shape of the pixels corresponding to the image-independent print data in the window of pixels is defined by an arrangement of the pixels corresponding to the image-independent print data that are present in the window of pixels.

The machine-readable instructions 708 may cause the processor to cause a print to be generated based on the changed property of the image-independent print data. For example, the processor may provide the print data to a printer device for generating the print (printing the document based on the print data).

In some examples, the processor may further access a second window of pixels corresponding to the print data, determine a second characteristic associated with the second window of pixels, and change, within the second window of pixels, a second property of the image-independent print data in the second window based on the second characteristic. For example, the processor may analyze a plurality of windows of pixels, which may cover the entire area of the print data.

FIG. 8 depicts a flow diagram of an example hardware block implementation for, as disclosed herein throughout, modifying a property of the image-independent print data based on a characteristic of a window of pixels. As shown, processing may be performed on CMYK color separated pixels (in which a color value of 0 indicates no toner for a color is to be applied and 255 indicates maximum amount of toner for the color is to be applied). In the example of FIG. 8, one pixel per clock cycle is illustrated. As illustrated, various operations of modifying a property of the image-independent print data based on a characteristic of a window of pixels may occur at a given clock stage of a processor, such as processor 102 illustrated in FIG. 1.

For example, at clock stage 1, the processor may access an image window (such as the window of pixels 302 illustrated in FIGS. 3, 4A, and 4B), which may include the source (original document image, which may be processed for printing) and OT plane (which may include overlaid data, including the security pixels).

In some examples, at clock stage 2, the processor may identify security pixels in the image window based on SecPxl flags that identify which one (if any) of the pixels in the image window includes a security pixel. In some examples, such as shown in FIG. 8, UCA may be performed at clock stage 2.

In some examples, at clock stage 3, the processor may perform a bloom check to identify pixels to which a security pixel may be bloomed based on bloom enable bits. Based on the bloom check, the processor may determine whether the center pixel of the image window is a security pixel and set the bloom bypass value. The processor may also generate a weighted sum of color values (such as the aggregate color values described herein) based on configurable weights.

In some examples, at clock stage 4, the processor may perform a tone region check to identify a characteristic of the image window. The processor may set the tone bypass value based on the tone region check. The processor may also pass along staged sums for indexing a LUT.

In some examples, at clock stage 5, the processor may convert from the CMY color space to the CMYK color space by performing under color reduction (UCR), which may be the reverse of UCA. The processor may use LUT controls for color lookups and Mono mode processing for monochromatic processing. Depending on the bloom bypass value and determination of whether the security pixel is the center pixel of the image window (both of which may be determined at clock stage 3) and tone bypass value (which may be determined at clock stage 4), the processor may bloom the security pixel to the center pixel (if the center pixel is not already the security pixel and the bloom bypass value indicates bloom is to be performed) and/or adjust a tone or color of the center pixel (if the tone bypass value indicates tone adjustment is to be performed) based on the LUT and tone sums. If no blooming is to be performed and no tone adjustment is to be made, then the original center pixel may be printed unchanged. Thus, the post-processing center pixel may have been bloomed to include a security pixel, changed to alter its tone based on LUT controls or mono mode processing, or left unchanged based on processing at clock stages 1-5.

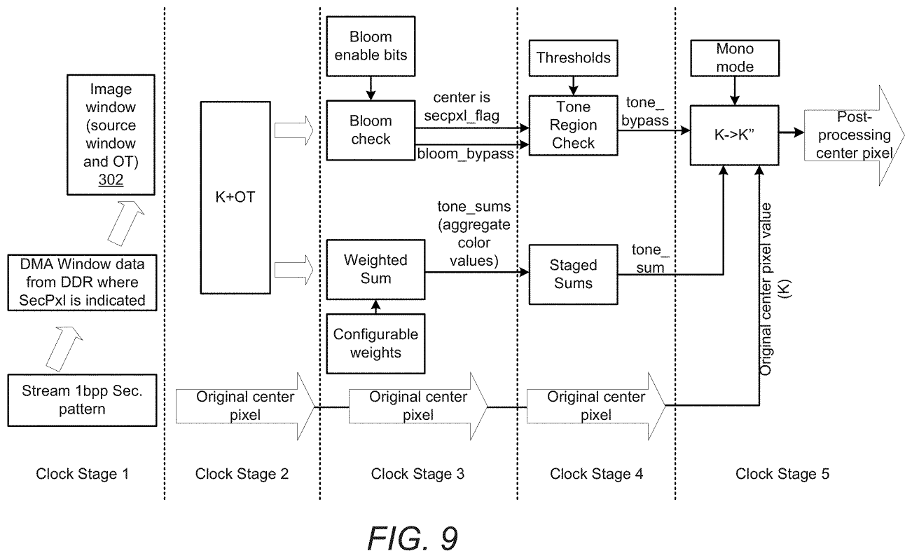

FIG. 9 depicts a flow diagram of an example hardware block implementation for, as disclosed herein throughout, modifying a property of the image-independent print data based on a characteristic of a window of pixels for monochromatic data.

As illustrated, various operations of modifying a property of the image-independent print data based on a characteristic of a window of pixels for monochromatic data may occur at a given clock stage of a processor, such as processor 102 illustrated in FIG. 1.

For example, at clock stage 1, the processor may access an image window (such as the window of pixels 302 illustrated in FIGS. 3, 4A, and 4B). The processor may stream a 1bpp security pattern. DMA window data from DDR where the SecPxl flag is indicated may be accessed to generate the image window (which may include the source window (original document image) and the OT plane, which may be generated based on processing at clock stage 1.

In some examples, at clock stage 2, the processor may access K values (since only the K plane may exist in monochromatic examples).

In some examples, at clock stage 3, the processor may perform a bloom check and determine a weighted sum. Processing at clock stage 3 may be similar to clock stage 3 illustrated at FIG. 8, except that only the K color value may be processed instead of CMY color values.

In some examples, at clock stage 4, the processor may perform a tone region check and pass staged sums. Processing at clock stage 4 may be similar to clock stage 4 illustrated at FIG, 8, except that only the K color value may be processed instead of CMY color values.

In some examples, at clock stage 5, the processor may, depending on the tone bypass, tone sum, bloom bypass, and whether the center pixel is a security pixel, generate a post-processing center pixel. Whether to bloom and/or whether to adjust the tone may be similar to the processing at clock stage 5 illustrated at FIG. 8, except that tonal adjustment may be based on a K tone to a K″ tone based on mono mode processing. Such mono mode processing may convert one K tone to another K tone, such as by adjusting grayscale. In some examples, such adjustment may use a grayscale lookup table, which may be predefined and/or configurable.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor to:
access a window of pixels corresponding to print data, the print data specifying printing of a plurality of pixels based on an original document image and image-independent print data;
identify a first pixel, from among the window of pixels, corresponding to the image-independent print data;
determine a characteristic associated with the window of pixels;
determine, based on the characteristic, that the image-independent print data is to specify printing of a second pixel from among the window of pixels; and
cause the image-independent print data to specify printing of the second pixel based on the determination that the image-independent print data is to specify printing of the second pixel.

2. The apparatus of claim 1, wherein to determine the characteristic, the processor is further to:
determine a level of darkness of the window of pixels.

3. The apparatus of claim 2, wherein to determine the level of darkness, the processor is further to:
determine, for one or more pixels in the window of pixels, a value of a color of each pixel of the one or more pixels; and
calculate an aggregate color value based on an aggregation of each value of the color determined for each pixel of the one or more pixels, the level of darkness being based on the aggregate color value.

4. The apparatus of claim 3, wherein the color comprises at least one of Cyan, Magenta, Yellow, or Black.

5. The apparatus of claim 3, wherein a respective aggregate color value is calculated for each of a plurality of colors to generate a plurality of aggregate color values, the level of darkness being based on the plurality of aggregate color values.

6. The apparatus of claim 5, wherein the processor is further to apply a weight to each respective aggregate color value.

7. The apparatus of claim 6, wherein the processor is to further apply a different weight to an aggregate color value of a pixel in the window of pixels based on a distance between the first pixel and the pixel.

8. The apparatus of claim 3, wherein the processor is further to:
change a color of each of the first pixel and the second pixel based on the aggregate color value.

9. The apparatus of claim 2, wherein the processor is further to:
compare the level of darkness to a threshold level of darkness; and
determine that the level of darkness exceeds the threshold level of darkness, wherein the processor is to determine that the image-independent print data is to also be printed at the second pixel based on the determination that the level of darkness exceeds the threshold level of darkness.

10. The apparatus of claim 1, wherein to determine that the image-independent print data is to also be printed at the second pixel, the processor is further to:
identify a direction from the first pixel to which to expand the image-independent print data to change a shape of the image-independent print data.

11. A method, comprising:
accessing, by a processor, a window of pixels corresponding to print data, the print data comprising an original document image and image-independent print data;
determining, by the processor, a characteristic associated with the window of pixels; and
changing, by the processor, within the window of pixels, a property of the image-independent print data based on the characteristic, the property comprising:
a size of the image-independent print data in the window of pixels, the size being defined by a number of pixels corresponding to the image-independent print data that are present in the window of pixels, and/or
a shape of the pixels corresponding to the image-independent print data in the window of pixels, the shape being defined by an arrangement of the pixels corresponding to the image-independent print data that are present in the window of pixels.

12. The method of claim 11, wherein the window of pixels comprises a first pixel corresponding to the image-independent print data, and wherein changing the property of the image-independent print data comprises:
changing the size by identifying a second pixel from among the window of pixels that is to include the image-independent print data.

13. The method of claim 11, wherein the window of pixels comprises a first pixel corresponding to the image-independent print data, and wherein changing the property of the image-independent print data comprises:
identifying a direction from the first pixel to which to expand the image-independent print data to change a shape of the image-independent print data.

14. An apparatus comprising:
a processor to:
access a window of pixels corresponding to print data, the print data comprising an original document image and image-independent print data;
determine a characteristic associated with the window of pixels; and
change, within the window of pixels, a property of the image-independent print data based on the characteristic, the property comprising:
a size of the image-independent print data in the window of pixels being defined by a number of pixels corresponding to the image-independent print data that are present in the window of pixels, and/or
a shape of the pixels corresponding to the image-independent print data in the window of pixels is defined by an arrangement of the pixels corresponding to the image-independent print data that are present in the window of pixels; and
cause a print to be generated based on the changed property of the image-independent print data.

15. The apparatus of claim 14, wherein the processor is further to:
access a second window of pixels corresponding to the print data;
determine a second characteristic associated with the second window of pixels; and
change, within the second window of pixels, a second property of the image-independent print data in the second window based on the second characteristic.
